(19) United States
(12) Patent Application Publication
(10) Pub. No.: US 2006/0024139 A1
(43) Pub. Date: Feb. 2, 2006

(54) Penumatic device for transferring materials

(75) Inventor: Placido Giusto, Torino (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: Herrblitz Modular Systems S.R.L., Torino (IT)

(21) Appl. No.: 11/192,010

(22) Filed: Jul. 29, 2005

(30) Foreign Application Priority Data
Jul. 29, 2004 (EP) 044255859

(51) Int. Cl. B65G 51/08

(52) U.S. Cl. 406/10

(57) ABSTRACT

A pneumatic device for transferring materials arranged in batches and/or randomly having an alternate movement for transporting the materials with two-way stroke speeds that can be made different, including a raceway for supporting the materials connected to a pneumatic cylinder sliding with an alternate movement along a tubular stem, secured to a support frame and including a manifold communicating with a compressed air system and connected to at least one pneumatic supply nozzle; a piston inside the pneumatic cylinder supported by the stem and including at least two surfaces shaped as a frustum of cone for supplying and discharging compressed air and a plurality of radial holes to allow a pneumatic connection of the chambers of the pneumatic cylinder with the surfaces; a spring to keep the piston in an end-of-stroke position; and at least two exhausts that communicate with one chamber.

### BACKGROUND OF THE INVENTION

1. Field of the Invention

The present invention refers to a pneumatic device for transferring various types of materials organized randomly or in batches.

2. Discussion of the Background Art

The background art provides for several arrangements for transporting materials that operate both continuously and discontinuously. These known conveyors are, for example, of the roller, band, chain, vibrating, pusher roller or trolley type. Pneumatic conveyors that take care of transferring powdery or granular solid substances inside tubing through an air current with adequate speed are also known.

The background art further provides for pneumatically-operated handling devices for in-batch or random materials having a reciprocating movement and generally comprising at least one power cylinder and one different stroke speed adjusting device. It is obvious that such known devices have greater sizes and costs with respect to a device that provides for an arrangement aimed to integrate power cylinder and adjusting device.

### SUMMARY OF THE INVENTION

An object of the present invention is solving the above background art problems by providing a pneumatic device for transferring materials in batches or random equipped with an alternate transport movement in which the power cylinder integrates a stroke speed adjusting device for the cylinder itself allowing to obtain, with the same encumbrance with respect to similar known devices, a higher available power.

The above and other objects and advantages of the invention, as will appear from the following description, are obtained by a pneumatic device for transferring materials as claimed in claim 1. Preferred embodiments and non-trivial variations of the present invention are claimed in the dependent claims.

### BRIEF DESCRIPTION OF THE DRAWINGS

The present invention will be better described by some preferred embodiments thereof, given as a non-limiting example, with reference to the enclosed drawings, in which:

FIG. 1 is a front sectional view of two parts of an embodiment of the pneumatic device according to the present invention;

FIG. 2 shows a side sectional view of the two parts shown in FIG. 1;

FIG. 3 shows a side sectional view of an operating step of an embodiment of the pneumatic device according to the present invention;

FIG. 4 shows a side sectional view of another operating step of an embodiment of the pneumatic device according to the present invention shown in FIG. 3;

FIG. 5 shows a side sectional view of an operating step of another embodiment of the pneumatic device according to the present invention; and

FIG. 6 shows a side sectional view of another operating step of the embodiment of the pneumatic device according to the present invention shown in FIG. 5.

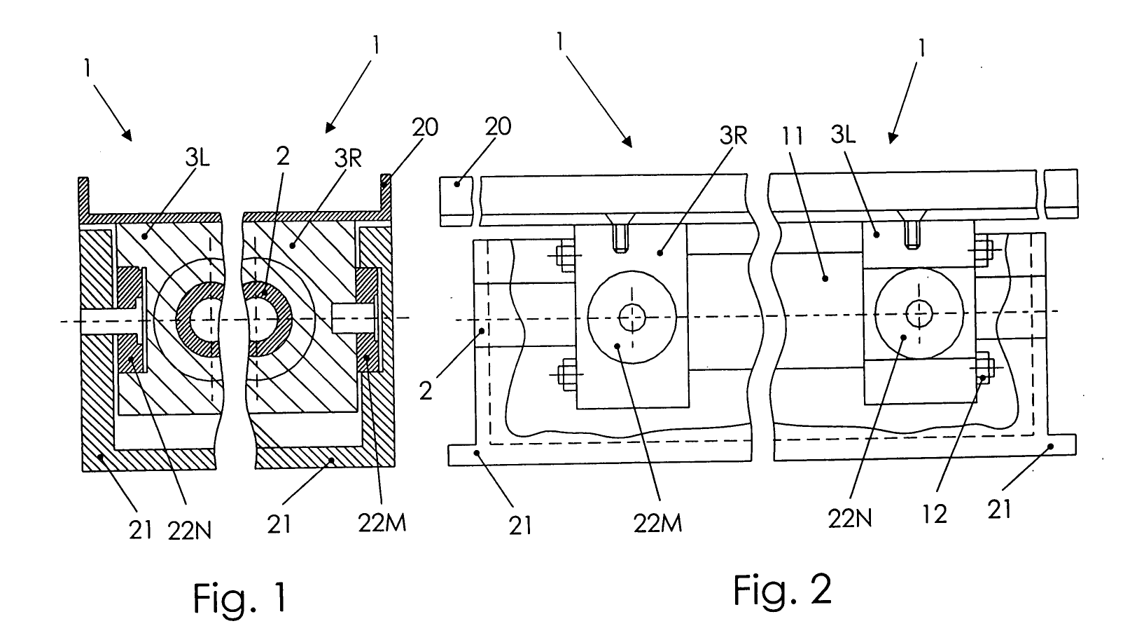

### DESCRIPTION OF THE PREFERRED EMBODIMENTS

With reference to the Figures, it is possible to note that the pneumatic device 1 for transferring materials according to the present invention is composed of one raceway 20, on which the materials to be transferred are laid, connected to a pneumatic cylinder 11, comprising a containment case 3C, two heads 3R and 3L and constrained by means of at least two tie rods 12, whose piston 5 is supported by a stem 2 secured to a supporting frame 21. The piston 5 realizes, inside the pneumatic cylinder 11, two chambers R and L which, suitably supplied and discharged with compressed air, make the cylinder 11 reciprocate.

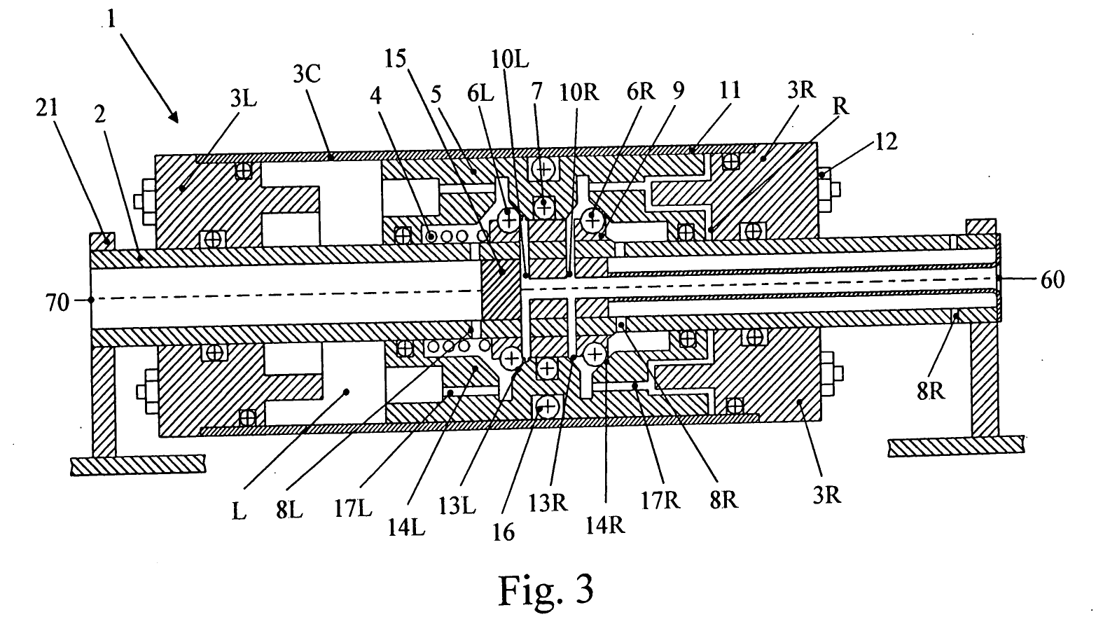

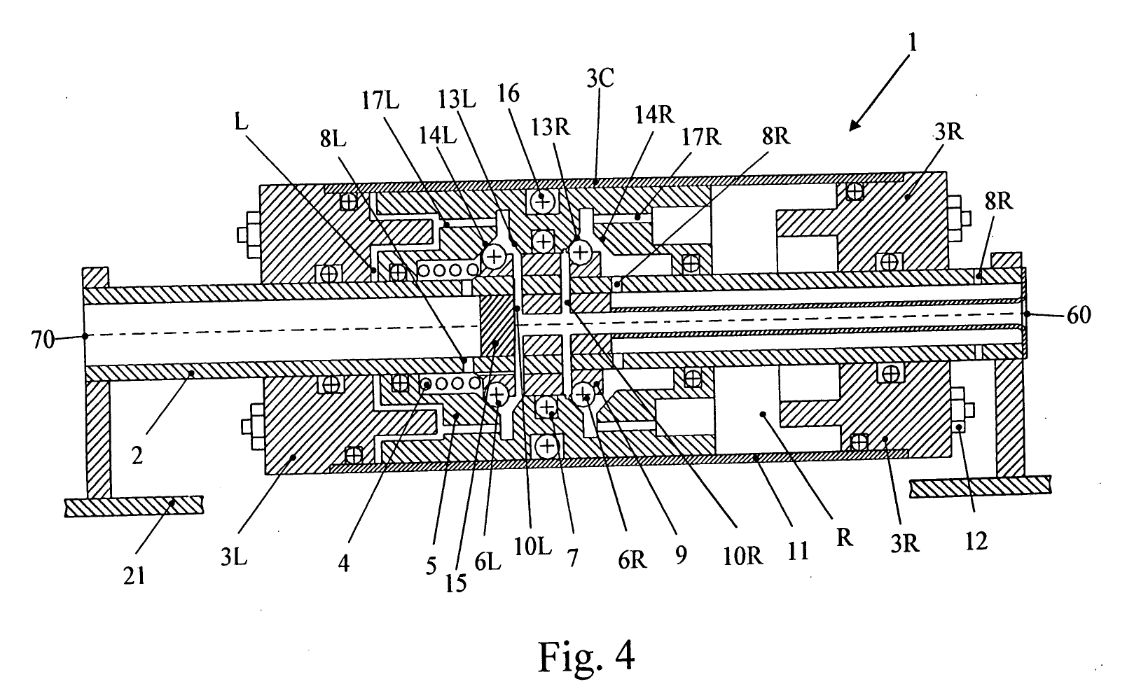

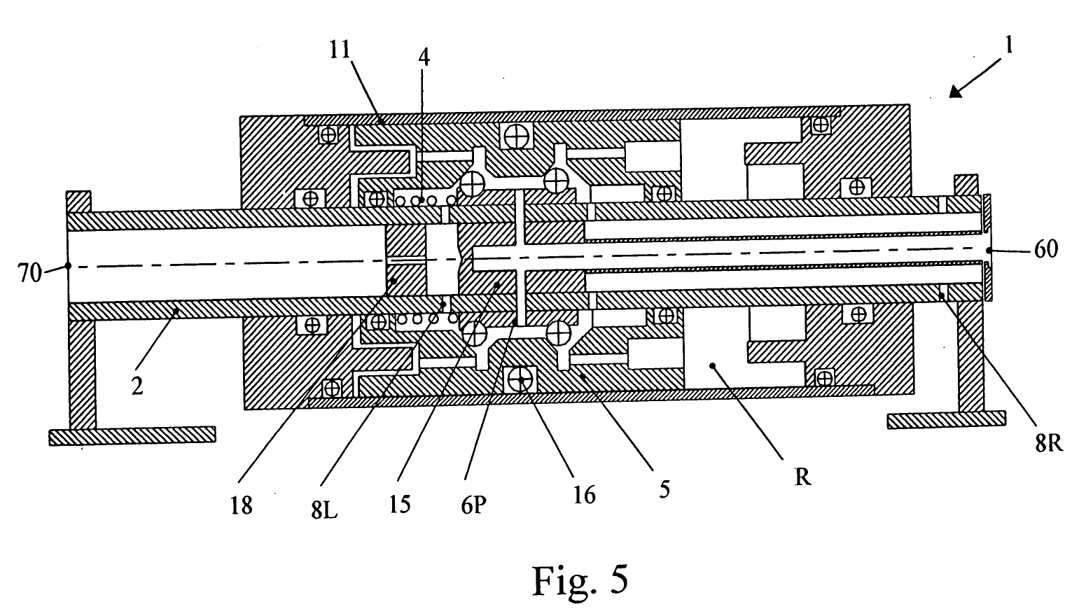

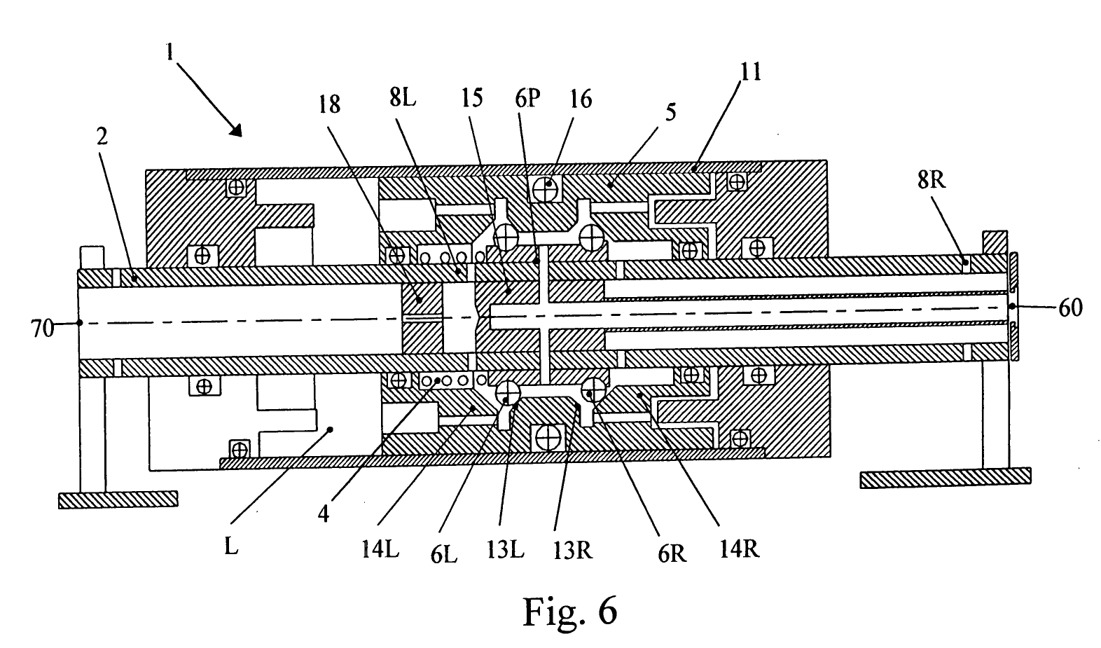

The stem 2 has a tubular cylinder section and the cylinder 11 slides along its longitudinal axis. A ring 9 is secured to the stem 2 in order to guarantee a pneumatic seal. Moreover, two housing seats, respectively for two O-rings 6L and 6R, are obtained on the stem 2. Inside the stem 2, a manifold 15, connected to the compressed air delivery system 60, is placed and secured with pneumatic seal. In a first embodiment of the present invention, either the pneumatic supply nozzles 10L and 10R, as shown in FIGS. 3 and 4, are connected to the manifold 15, or, in an alternate embodiment of the present invention, a pneumatic supply nozzle 6P, as shown in FIGS. 5 and 6, is connected to the manifold 15. The stem 2 is further equipped with at least two orifices 8L and 8R, which will be described below.

Inside the piston 5, four surfaces 14L, 13L, 13R, and 14R shaped as a frustum of cone are obtained for supplying and discharging air and the O-rings 6L and 6R are assembled between such surfaces. Moreover, inside the piston 5, a plurality of radial holes 17R and 17L are obtained, which allow the pneumatic connection of the two chambers R and L of the pneumatic cylinder 11 with the frustum-of-cone-shaped surfaces 14L, 13L, 13R, and 14R for supplying and discharging. In the embodiment of the present invention in which two pneumatic supply nozzles 10L and 10R can be found, the piston 5 is equipped inside with a housing seat and a O-ring 7; in another embodiment of the present invention in which a single supply nozzle 6P is provided, such sealing ring 7 and its related seat are missing.

The piston 5 is further equipped, on an external surface thereof, with a housing seat and a pneumatic sealing ring 16.

Coaxially with the stem 2, a spring 4 is placed, which, when there is no compressed air supply to the device 1, keeps the piston 2 in an end-of-stroke position, in particular with a first surface 13L shaped as a frustum of cone that abuts against the sealing ring 6L and with a second surface 14R shaped as a frustum of cone that abuts against the sealing ring 6R.

The alternate movement of the cylinder 11 is supported by at least two wheels 22M directly assembled onto the cylinder 11 itself or, alternatively, by two wheels 22N secured onto the frame 21. Alternatively the wheels 22M or 22N can be replaced with linear ball bearings, roller bearings or support slides (not shown).

A description of a possible operating cycle of the device 1 according to the invention will be described below, merely as a non-limiting example.

With reference to the cycle starting condition generated by the thrust of the spring 4 shown in FIG. 3, the piston 5 is offset rightwards with respect to the piston 11 so that, by inserting compressed air from the compressed air delivery system 60 into the chamber R of the cylinder 11 by means of the manifold 15 and the nozzle 10R, such air entering the chamber R through the open frustum-of-cone-shaped surface 13R and the radial holes 17R, the cylinder 11 moves rightwards; simultaneously, air contained in the chamber L is discharged outside the device 1 through the radial holes 17L, the open frustum-of-cone-shaped surface 14L, the orifices 8L and the exhaust 70.

In the right end-of-stroke, the cylinder 11 will exert an axial thrust onto the piston 5 moving this latter rightwards too, so that the previously-described supply and discharge conditions will be reversed. In particular, as shown in FIG. 4, the compressed air coming from the manifold 15, through the nozzle 10L, the open frustum-of-cone-shaped surface 13L and the radial holes 17L enters into the chamber L and consequently the cylinder 11 will move leftwards, thereby assuming the position shown in FIG. 3 and described previously. Simultaneously, the air contained in the chamber R is discharged outside through the radial holes 17R, the open frustum-of-cone-shaped surface 14R and the orifices 8R. At the end of the leftward stroke of the cylinder 11, the piston 5 will be again pushed leftwards so that, without interruptions, the previously-described air supply and discharge conditions will be reproduced.

In the embodiment of the device 1 equipped with two pneumatic supply nozzles 10L and 10R separated by the O-ring 7, the different two-way speeds of the cylinder 111 according to the present invention are realized by making the pneumatic flow-rate of the nozzles 10L and 10R different.

In the alternative embodiment of the device 1 equipped with a single pneumatic supply nozzle 6P, the different two-way speeds of the cylinder 11 are obtained by suitably calibrating the air discharge flow-rates, for example by interposing a throttling device 18 upstream of the exhausts.

1. A pneumatic device for transferring various type of materials arranged in batches and/or randomly characterized by an alternate movement for transporting said materials having two-way stroke speeds that can be made different, comprising:
a raceway configured to support said materials to be transferred, said raceway being connected to a pneumatic cylinder sliding with an alternate movement along a tubular stem, secured to a support frame, configured to carry and discharge compressed air supply;
a piston of said pneumatic cylinder supported by said tubular stem and configured to determine the sliding end-of-strokes of said pneumatic cylinder, said piston realizing two chambers inside said pneumatic cylinder and comprising at least four surfaces shaped as a frustum of cone for supplying and discharging said compressed air, at least two sealing rings being assembled between said at least four surfaces, and a plurality of radial holes adapted to allow a pneumatic connection of said chambers of said pneumatic cylinder with said at least four surfaces, said tubular stem comprising a manifold communicating with a compressed air system and connected to at least one pneumatic supply nozzle configured to supply said compressed air to said chambers and to allow an alternate sliding movement of said pneumatic cylinder;
a spring arranged coaxially with said tubular stem and configured, when there is no compressed air supply to said device, to keep said piston in an end-of-stroke position; and
at least two exhausts of said compressed air, each exhaust communicating with one of said chambers.

2. The pneumatic device according to claim 1, wherein a sealing ring configured to guarantee a pneumatic seal is secured to said tubular stem.

3. The pneumatic device according to claim 1, wherein said piston comprises an external surface including a housing seat for a pneumatic sealing ring.

4. The pneumatic device according to claim 1, wherein said tubular stem comprises two housing seats for two pneumatic sealing rings.

5. The pneumatic device according to claim 1, wherein said manifold is connected to at least two pneumatic supply nozzles separated by a pneumatic sealing ring.

6. The pneumatic device according to claim 1, wherein said alternate movement of said pneumatic cylinder is supported by at least two wheels secured to said pneumatic cylinder.

7. The pneumatic device according to claim 1, wherein said alternate movement of said pneumatic cylinder is supported by at least two wheels secured to said support frame.

8. The pneumatic device according to claim 1, wherein said alternate movement of said pneumatic cylinder is supported by at least one of linear ball bearings, roller bearings, and support slides.

9. The pneumatic device according to claim 1, wherein said two-way speeds that can be made different of said alternate movement of said pneumatic cylinder are realized by reducing an air flow-rate of said air exhausts by interposing a throttling device.

10. The pneumatic device according to claim 5, wherein said two-way speeds that can be made different of said alternate movement of said pneumatic cylinder are realized by making the compressed air flow-rates of said two pneumatic supply nozzles mutually different.
